(19) United States
(12) Patent Application Publication
(10) Pub. No.: US 2017/0251696 A1
(43) Pub. Date: Sep. 7, 2017

(54) PRE-BLENDED AND PACKAGED FROZEN SMOOTHY NUTRITION MIX, METHOD AND PRODUCT

(71) Applicant: Stephen SIMONS, Thunder Bay (CA)

(72) Inventor: Stephen SIMONS, Thunder Bay (CA)

(21) Appl. No.: 15/452,200

(22) Filed: Mar. 7, 2017

(30) Foreign Application Priority Data
Mar. 7, 2016 (GB) GB-1603900.0

(51) Int. Cl. A23G 9/52; A23L 3/365

(52) U.S. Cl. CPC A23G 9/52; A23L 3/365; A23V 2002/00

(57) ABSTRACT

This invention provides an improved method for making a blended liquid or frozen combination and mixture of pre-ripened fruits and vegetables, including juiced foods, protein, vitamins, nuts, seeds, milks, juices, yogurt, herbs, spices, coffee, tea or other freeze dried super foods, herbal or non-herbal medicine, to make a frozen smoothie mixture. An initial mixture of food components, with limited or no liquid added for processing, is pre-blended together continuously until it forms a suitable consistency. The blending grinds the food components together into a uniform and consistent mixture with a high degree of suspended solid particles and fibers broken down from their initial state. The pre-blended mixture is then poured into a shaking or mixing container. The pre-blended mixture in the container is continually shaken or mixed to form and maintain uniformity and a suitable consistency. The pre-blended smoothie ingredients are then poured while in motion into a shaping mold and frozen. Freezing is preferably into a plurality of frozen pieces. The frozen pre-blended mixture, frozen or not, may be used to pair with other fruits and vegetables to be packaged as a whole, or, is as an added ingredient store for use in a frozen beverage subsequently blended.

This application claims priority from GB-1603900.0 having a filing date of Mar. 7, 2016.

### FIELD OF THE INVENTION

The field of the invention relates to pre-blended and pre-assembled frozen components for fast and convenient rendering, pairing, and re-using food products into a finished and packaged frozen smoothie mix, which, can be added to other ingredients and re-blended for retail or private consumption.

### BACKGROUND OF THE INVENTION

Frozen drinks, slushies, flavored shaved ice, smoothies have long been known and are widely consumed throughout the world. Frozen drinks of various types have been made to enjoy on a hot day, or as a meal supplement. These drinks have been provided throughout restaurants and households for many years.

Most frozen drinks are manually blended for consumption from individual components, some frozen, some merely refrigerated, others stored at room temperature, such as ice, syrups, fruit, sorbets, yogurt, coffee and tea. There are many ways these ingredients arrive at the traditional blending stage (the last stage) when a frozen drink is prepared for consumption.

Most restaurants serving these beverages are required to have a significant amount of freezer and other storage space for the variety of ingredients necessary to supply customers, thus promoting:
1. costly food waste in grocery stores, restaurants, and homes,
2. higher emissions,
3. taking away from floor space,
4. adding to high costs of hydro a maintenance and
5. to make smoothies there are continuous and costly efforts for staff training to achieve and maintain a uniform consistency when manually mixing different volumes of different ingredients hat have a different property state, while mixing these different states together to achieve the consistency for each individual drink blended.

Example: when liquid components meet frozen. When a frozen drink or slushy beverage is prepared by staff, gloves or washing of hands is mandatory during the making of the frozen beverage. Thus, the process is more time consuming, and consumes more energy and results in confusion behind the counter. This process does not work well for many establishments, particularly because of constantly wasting time, money, and food. With large lineups, it is difficult for even the best frozen drink operator to blend consistent drinks with exact recipes the same way, quickly, and every time, in accordance with stated nutritional data claims that have been provided to the consumer. Such nutritional information is increasingly required by regulation and industry practice. Essentially the frozen components are organized from storage but remain in a random sized condition with different sizes, shapes, dates of use, sources and application.

Another concern is the amount of wasted fruits and vegetables in grocery stores and restaurants that offer/sell produce and dairy.

Of particular concern is utility in small space footprint operations which are the most used and least expensive retail space leasing arrangements. In these situations, every element of supply, storage, assembly and delivery is subject to regulatory and spatial constraints which directly affect timely production, food waste and the bottom line, all in full view of the retail consumer.

In many occasions a grocery store, or other retail business, will have spoilage of fruit or vegetables if the demand decreases. Sometimes this is a significant amount, particularity for grocery stores.

The term “slushy or smoothie” is commonly used in homes and restaurants for a mixture of a food, ice and liquid blended together to form a drink. Typically a slushy would have a large component of shaved, but separate, ice particles in a flowable condition.

Smoothies often made from a collection of frozen components such as frozen yogurt, frozen fruit sections or berries plus one or more solid food products such as nuts, plus one or more powdered food products combined with a liquid such as water or juice for processing. Many of these items require attention and resources to maintain their condition and freshness while other must be segregated altogether.

Basically each separate component must be provided its own separate staging and preservation station and the skilled and attentive operator assistance to provide for consistency across the myriad of choices available to the consumer.

In the process as a whole, skilled and attentive labour is required at separate stages, firstly upon preparation and storage of the individual components, and, then, again upon assembly and finishing. Individual frozen components become a noisy addition to the final stage especially if accompanied by an amount of hard unblended or partially blended water ice. This final blending not only is irritating to the customers and the operator but is very hard on equipment, shortening the lifetime of even the most durable and expensive commercial machines. Additionally extra time is required in the processing step.

### PRIOR ART

In successful prior art processes for smoothy preparation the steps include:
packing, transporting and maintaining individual components,
cutting, segregating and, portioning irregular portions of individual foods,
freezing those which are perishable and benefit from storage while frozen,
assembling those not requiring storage in a frozen state,
assembly the food ingredients from this variety of sources at the time of final preparation for consumption,
adding liquid such as water or juice as a processing agent, and
grinding and blending the assembly into a smoothy or slushy.

Examples of the patent attempts to improve production of smoothy and slushy food products are shown in;

CA 2,204,467 issued to The JEL Sert Co.—for a Freezable Confection And Method For Making Same,

CA 2,841,908—issued to Dole Packaged Foods, LLC—for a Yogurt Smoothie Kit And Methods For Making The Same,

CA 2,577,163—issued to Smoo PTY Limited—for a Sealed Pack Of Ingredients For An Individual Smoothie, And Associated Methods And Apparatuses,

And U.S. Patent application 2007-0042090 applied for by Birds Eye Foods, now abandoned.

Though such frozen drinks have achieved considerable popularity and commercial success, there has been a continuing need for improvement to quicken the process, save food before it is wasted, lessen costs, lessen processing complexities and equipment, maintain uniformity and make it more accommodating to serve frozen healthy drinks regardless of the size of the business or potential risk of food waste.

### Objects

It is the objective of the invention to provide a means for grocery stores and many retailers to transform imperfect and non-display worthy fruits and vegetables, and dairy that is close to its expiration date, into a new uniform ingredient and/or product, stored in a different state (frozen), and may achieve a new best before date. Absent processing, this food would ultimately be deemed not fit for sale, and would be thrown in the garbage.

It is another object of the invention to provide a process that will help to prevent waste, whether or not it processes is less than perfect, or bruised elements, or dairy foods getting close their expiry date in grocery stores, restaurants, buffets, cafeterias, lunchrooms, or for home use.

It is still another objective to speed up processing time, eliminate cost and space requirements, make better and more cost effective use of skilled resources and provide for a more uniform product in a retail environment with unstable activity levels.

It is a further object to have a single assembly step where any manual measurements which may be required can be contained in a controlled environment without the pressures of a retail counter or family gathering.

It is yet a further object to improve a method to make more use of a factory environment.

A still further object is to reduce the noise and machine wear at the customer level and make more and better use of industrial blending techniques.

It is an object of the invention to improve production of uniform smoothy products.

It is a further object to make use of re-using food products that are less than ideal at retail or set to expire or have limited remaining shelf life or unit for sale due to bruising or imperfections.

### The Invention

The invention provides an improved method of pre-forming a frozen smoothy component comprising:
assembly of the main ingredients in added water,
shearing as in mixing and blending. The assembly by into a uniform consistency,
continually moving the blend mixture,
freezing the moving blended mixture
packing, shipping, storing and reblending the pre-blended mixture with added liquid components.

In a another aspect this invention, pre-blending of ingredients creates a uniform and consistent smoothie liquid which is the first stage of production and not the last. After the pre-blended smoothie liquid is created, it is then poured into a mold rather than into a cup for consumption. Once freezing the mix has reached a frozen state, it can then be manufactured into a frozen smoothie mixture component that can be packaged in consumption units adapted to be re-blended with other ingredients into a liquid or frozen smoothie finished product.

In another aspect the invention provides a method for making a liquid drink or batch which consists of a pre-blended mixture of any combination of pre-ripened fruits, vegetables, juiced fruits a vegetables, nuts, yogurt, herbs, spices, coffee, tea, vitamins, proteins, honey, pro-biotics, freeze dried super foods, fulvic plant and earth minerals, herbal or non herbal medicines which are combined and mixed together in any quantity or variation with any possible combination of ingredients including organic nutrients, vitamins, and all medicines.

### PREFERRED EMBODIMENTS

In a preferred environment food ingredients are assembled and pre-blended into a desired consistency, including texture and flavor, preferably without added water. They are then put into a container and continuously mixed, spun, or turned together to maintain the desired consistency and volume, including taste and texture, while accurately targeting key nutritional data for the pre-blended mixed batches.

The continuous shaking, spinning or turning in the container avoids the different ingredients settling or separating as the liquid is prepared, before and during the pouring of the liquid into a mold or molds and frozen in that blended uniform and consistent state.

This liquid formation makes a blend of its own type and of its own unique consistency and allows the manufacturer to control the taste and consistency thereof when combined with other foods.

The process allows the manufacturer to create a desired flavor, texture, and to have predetermined quantities of ingredients in the liquid throughout the freezing process. This allows the manufacturer to meet the targeted nutritional content to be exact in the pre-blended and packaged nutritional frozen smoothie mixture.

The freezing stage preserves the exact nutritional content and taste of the pre-ripened and mixed ingredients after they are broken down and blended into uniformity.

Once the blended mixture is frozen the manufacturer may accurately make measurements of the weight and size of the already frozen mix and subdivide the pre-blended mixture.

The frozen matter is evenly or unevenly divided into individually pre-blended and packaged consumption units each a frozen smoothie mixture unit, which then on its own can be once again blended and enjoyed as a frozen health drink, or the frozen mixture can be added to other ingredients and sealed before storing and preparing.

The combination of shearing or blending and maintaining motion achieves uniformity in the consumption units and substantially decreases the energy and time required for subsequent re-blending as the consumer unit does note contain substantial chunks of unblended water ice.

In a third aspect of the method of the invention ripened fruit or vegetables are blended as in mixed by violent shearing, in any combination with any variety or quantity of natural juices, juiced fruits and vegetables, nuts, yogurt, juices, milks, herbs, spices, coffee, tea, vitamins, proteins, freeze dried super foods, herbal and non-herbal medicines, fulvic plant and earth minerals and then poured in a container or mixing drum where motion within the pre-blended mixture maintains a uniform consistency.

Proper Nutritional values, taste and purity of the pre-ripened and blended fruits or vegetables and including all other natural and organic ingredients are preserved through the change of state from liquid to frozen.

More particularly, combining yogurt, with milk, juices, fruits, protein, vegetables and super foods are blended as by violent shearing to form a particular texture. This container is then continuously shaken or spun or turned before a while the mixed liquid batch is poured into the freezing mold. The more intense the shaking or spinning of the closed container with the mixture the more the process allows air to enter into the mixed liquid, making it expand, giving it more volume which can ultimately change the density of the pre-blended frozen nutrition mixture.

In a forth aspect, the pre-blended mixture contained in the freezing mold can be in the mold by itself or it can have any other solid, powdered, or other food added to the individual freezer mold itself before or after it has changed from liquid into a solid frozen state altogether.

In a fifth aspect of the invention, the method of the freezing molds containing the pre-blended mixture, with or without solid pieces or other foods added to it, are then placed into freezing racks or on a conveyor belt going through flash freezing temperatures ranging from −5 to −75 degrees below Celsius. After freezing is completed these individually frozen shapes can have a net weight ranging upwards from 0.5 grams depending on the size of the mold that the liquid was poured and frozen into. Different sizes of freezer molds, and freezing temperatures determine the size and the weight and density of the individual frozen nutritional mixture or frozen consumption units that are added to a drink making machine (blender) and or packaged with other ingredients. These molds can range in size upwards from 1 cm in diameter or 1 cubic cm including any and all varieties of different shapes and sizes. Any shapes, sizes, and densities can be determined by the size of the mold that the pre-blended mixture batch is poured in.

For example: a long freezer mold can be put on a conveyor belt that runs batches of pre-blended mixture through a flash freezing stage. When the frozen pre-blended mixture is made in bigger freezer molds, it can be cut up and/or and divided into desired sizes and weight while frozen. Some freezer molds are much smaller and can be used to determine size and to control the weight of frozen matter for pre-selected sizes of the pre-blended and packaged frozen mixture mix.

The size of the freezer and subdivision of the bulk pre-blended mixture accommodates the manufacturing specifications as needed to meet packaging size, blender specifications, desired consistency, and targeted nutritional specifications that are preserved frozen in the package, and after other ingredients are added to the frozen mixture.

After determining the weight and size of the frozen mixture, it is then sorted and divided into small, medium or large packaging sizes and kept frozen. This frozen mixture once packaged can be accompanied with any other frozen food or any other solid food or powdered ingredients, then packaged again.

For example: Super foods, Frozen fruits and vegetables, or spices and herbs can be added to the frozen mixture in the package. The volume of frozen nutrition mixture required to make the drinks is determined by the desired size, nutritional data, and flavor that correspond to preparing that specific individual pre-blended frozen mixture, and with the other ingredients added to make a frozen smoothy.

The total size and frozen density of the individual frozen mixture plays a major role when the frozen contents in the package and other ingredients are mixed with a liquid and blended to a desired liquid consistency for a finished product. If the frozen mixture or pieces are too big, or to dense, it will be difficult for blender blades to run and will cause more wear on the blender, increasing heating of the product, making the drink too thick to drink or might take too long to prepare for a customer. If the frozen matter is too small the outcome of the frozen health drink may be to liquidy, losing its desired consistency after blending stage (last stage). When packaging the frozen mixture, or pieces it is important to pre-measure density, weight and size being packaged. This will determine the amount and size of other ingredients that can be added to a package or when added to the blender to achieve the desired consistency of the finished blended frozen drink. The frozen nutrition mixes, density, weight, and size also determines the type of mixer or blender that is to be used and programmed with an exact blender program to simplify quick preparation of the frozen health drinks and reduce blender wear.

The pre-blended frozen nutritional mixture is best stored in freezing temperatures −5 to −50 degrees Celsius before being added with other ingredients into a package, or combining with a liquid inside a blender to prepare a frozen health drink.

In all aspects once the frozen mixture or pieces are sorted, weighed and have reached their desired frozen density, it is then they can be added to packaging. In addition to the frozen mixture or pieces that are being put into the package, any other solid or other food, powdered or freeze dried fruits and vegetables, herbs, proteins and any other nutritious vitamins, herbal and non herbal medicines can be added before the frozen product consumption unit is packed and stored in any freezer that is set between the temperature of −5 degrees to −50 degrees Celsius. The amount of frozen mixture or pieces of frozen food matter that goes into the package is what determines the specific individual sizes of the frozen drinks that are being packaged into a new product.

According to a still further aspect of the invention, when the frozen nutrition mixture by itself, or with other contents, are combined with any liquid and are blended together, it is then that all ingredients from the first stage to the last stage of this invention are transformed into a uniform, and evenly mixed frozen smoothy or slushy drink.

Many variables determine the outcome of the drink sizes as well the drinks overall consistency and texture. These variables include, and are not limited to:
1. The density of the pre-blended frozen mixture may be determined by the amount of time, and freezing temperature that the mixture is frozen in during, and after production, the same rule applies for the ingredients that are added, and the package that it is stored in.
2. The individual sizes of the pre-blended frozen mixture or pieces of additional food in the package.
3. The type of blender being used.
4. The blender blades shape.
5. The blender speeds or rpms, of the motor.
6. The predetermined program of the blender.
7. The amount of liquid added to blender before, during or after the frozen mixture contents is added.

For example:

To reach the texture of a milkshake type consistency for a completed 12 oz drink, the controlled variables are as follows:
1. The pre-blended frozen mixture is stored −18 degrees Celsius.
2. The sizes of the frozen mixture or pieces and or other food pieces in package are roughly 10 cm×2 cm rectangular or 20 cm in diameter. The total weight of the contents of the package is 346 grams.
3. The type of blender being used is a commercial Vitamix™. Model # 30169.
4. Blade size is 10 cm in length.
5. The blender has a total 3 horsepower output.
6. Ramps up to MED (51%) for 10 seconds, then ramps up to HIGH (85%) for 10 seconds. Total blend time from when frozen meets liquid to finished product is 20 seconds.
7. The measured amount of liquid to be combined with frozen contents is 10 oz.

This is a new process to pre-blend and are manufacture foods, and foods that are close to expiring, into one uniform ingredient, that is changed from liquid to frozen, and reversing its stages from frozen back to liquid, and used to mix and combine with other complimentary ingredients to arrive at a finished product.

While the present invention has been described in connection with what is considered the most practical and preferred embodiments, it is understood that this invention is not limited to the disclosed embodiments but is intended to cover various arrangements and methods included within the spirit and scope of the broadest interpretations and equivalent arrangements.

What I claim is:

1. An improved procedure for production of a food product smoothy comprising:
(a) assembling a body of mixed food product materials containing a plurality of separate food product elements without adding additional liquid or water for processing,
(b) subjecting the food product body to mixing, blending and violent shearing adapted to reduce and reducing the body as a whole to a uniform non-frozen blended food product by breaking down fibrous or particulate components of said solid food elements,
(c) maintaining or reducing the temperature of the blended food product during the mixing, blending and violent shearing,
(d) maintaining the blended food product in motion adapted to reduce separation of the components of the blended food product,
(e) freezing the blended food product,
(f) separating the frozen food product into individual consumption units,
(g) maintaining the frozen state of the consumption units,
(h) at the time of consumption selecting one or more consumption units, adding a quantity of liquid food product and blending the mixture into a smoothy drink ready for consumption.

2. An improved procedure for production of a food product smoothy as claimed in claim 1 further comprising adding a liquid or water to said body in an amount sufficient for processing.

3. An improved procedure for production of a food product smoothy as claimed in claim 2 wherein said adding of liquid or water to said body is insufficient to provide for the formation of any chunks of solid water ice in the blended food product.

4. An improved procedure for production of a food product smoothy as claimed in claim claims 3 further comprising adding further food products to the blended food product prior to or during the freezing step.

5. An improved procedure for production of a food product smoothy as claimed in claim claim 1 wherein the plurality of separate solid food product elements includes elements sized to facilitate the mixing, blending and violent shearing.

6. An improved procedure for production of a food product smoothy as claimed in claim claim 1 wherein the plurality of separate solid food product elements includes both elements preserved in a frozen state and others preserved in an unfrozen state.

7. An improved procedure for production of a food product slushy comprising:
(a) assembling a body of mixed food product materials containing a plurality of separate food product elements,
(b) subjecting the food product body to mixing, blending and violent shearing adapted to reduce and reducing the body as a whole to a uniform non-frozen blended food product by breaking down fibrous or particulate components of said solid food elements,
(c) maintaining or reducing the temperature of the blended food product during the mixing, blending and violent shearing,
(d) maintaining the blended food product in motion adapted to reduce separation of the components of the blended food product and prevent the formation of chunks of solid water ice,
(e) freezing the blended food product,
(f) separating the frozen food product into individual consumption units,
(g) maintaining the frozen state of the consumption units,
(h) at the time of consumption selecting one or more consumption units, adding a quantity of liquid food product and blending the mixture into a slushy drink ready for consumption.

8. An improved procedure for production of a food product smoothy as claimed in claim 7 further comprising adding a liquid or water to said body in an amount sufficient for processing.

9. An improved procedure for production of a food product smoothy as claimed in claim 8 wherein said adding of liquid or water to said body is insufficient to provide for the formation of any chunks of solid water ice in the blended food product.

10. A food product smoothy comprising of pre-blended consumption unit produced in accordance with the procedure set out in claim 1.
